(19) United States
(12) Patent Application Publication
(10) Pub. No.: US 2006/0239497 A1
(43) Pub. Date: Oct. 26, 2006

(54) Loudspeaker having a separable diaphragm

(76) Inventor: Hungwen Yu, Shenzhen (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/406,301

(22) Filed: Apr. 19, 2006

(30) Foreign Application Priority Data
Apr. 21, 2005 (CN) 200520011863.5

(51) Int. Cl. H04R 9/06; H04R 11/02; H04R 1/00

(52) U.S. Cl. 381/398

(57) ABSTRACT

A loudspeaker having a separable diaphragm, comprises: a cone frame; a voice coil yoked in the cone frame and having a plurality turns of wire wound around the external of the voice coil; a diaphragm shaped as a cone structure and having an installation aperture in the middle of the bottom of the diaphragm, and installed on the hatch of the cone frame and located outside the voice coil; an elastic wave sheet having an installation aperture in the middle and yoked on the top of the voice coil; an elastic wave sheet connector set in the installation aperture on the elastic wave sheet; a diaphragm connector set on the outside of the bottom of the diaphragm; and a frame pressure ring installed on the top of the diaphragm and connected to the cone frame to fasten the diaphragm into the cone frame. The elastic wave sheet connector and the diaphragm connector are movably and separably connected. The frame pressure ring, the diaphragm and the cone frame are all movably and separably connected.

### FIELD OF THE INVENTION

The present invention relates to an audio loudspeaker of the sound system. More particularly, the present invention relates to a loudspeaker having a separable diaphragm.

### BACKGROUND OF THE INVENTION

Loudspeaker is a device frequently used as the sound system, which transform the electronic signals to the hearable audio signals.

The working theory of a loudspeaker is: a loudspeaker includes a frame having a magnet; a voice coil yoked in the frame; multi-turns of electrical wire wound around the external of the voice coil. The electrical wire generates magnetic force and repulsive force to the frame to move the voice coil to-and-fro. An elastic wave sheet and a diaphragm is stuck on the voice coil. The diaphragm is a cone-shaped film and is the major phonation member. The diaphragm moves to-and-fro following the elastic wave sheet and the voice coils and generates the vibration wave, so the audio frequency is hearable.

The current loudspeakers use the diaphragm as the major phonation part, which is fixed to the elastic wave sheet and the voice coils by means of a chemical bond. Hence they are hard to separate. A professional is required to maintain the damaged diaphragm, and sometimes the loudspeaker has to be taken apart from the sound system for repair.

Since the diaphragm is stuck to the voice coil, therefore, the diaphragm and the elastic wave sheet are fixed to the voice coil, and the stroke is also unchangeable. The relative structure of voice coils with the diaphragm and the elastic wave sheet is hard to separate. Therefore it's impossible to change the diaphragm according to the personal interest.

In a word, the current diaphragm is fixed to the elastic wave sheet and the voice coil of the loudspeaker. There are many drawbacks that can be improved accordingly.

### SUMMARY OF THE INVENTION

The main aspect of the present invention is to provide a separable connection between the diaphragm, the elastic wave sheet and the frame of a loudspeaker. The fixed position of the diaphragm is adjustable to the elastic wave sheet and the voice coils. Therefore, the diaphragm is easy to replace and repair.

A loudspeaker having a separable diaphragm, comprises:

a cone frame;

a voice coil yoked in the cone frame and having a plurality turns of wire wound around the external of the voice coil;

a diaphragm shaped as a cone structure and having an installation aperture in the middle of the bottom of the diaphragm, and installed on the hatch of the cone frame and located outside the voice coil;

an elastic wave sheet having an installation aperture in the middle and yoked on the top of the voice coil;

an elastic wave sheet connector set in the installation aperture on the elastic wave sheet;

a diaphragm connector set on the outside of the bottom of the diaphragm; and

a frame pressure ring installed on the top of the diaphragm and connected to the cone frame to fasten the diaphragm into the cone frame.

The elastic wave sheet connector and the diaphragm connector are movably and separably connected. the frame pressure ring, the diaphragm and the cone frame are all movably and separably connected.

The present invention has four major improvements by provides a separable connection between the diaphragm and the elastic wave sheet, between the diaphragm and the cone frame:

1. It is easy to separate the diaphragm from the loudspeaker. When the diaphragm is damaged or is affected by the damp, it will be easy to replace or repair without replace the loudspeaker;

2. Do It Yourself (DIY) or the like can easily be achieved to satisfy fans' requirements based on the convenience diaphragm reconstruction;

3. It is possible to adjust the relative position of the diaphragm and elastic wave sheet with the voice coils in order to adjust the stroke of the loudspeaker to gain a better quality.

4. The end user can change the diaphragms of improved quality to gain a better sound quality.

### BRIEF DESCRIPTION OF THE DRAWINGS

Combining the attached drawings, the following will describe the specific implementation means for the present invention in details, which will make the technical solution and other beneficial results for the present invention become obvious.

FIG. 1 is an explosion view of a first and a second embodiment of the present invention.

FIG. 2 is a section view of the first embodiment of the present invention in an explosion state.

FIG. 3A is a section view of the first embodiment of the present invention in an installation state.

FIG. 3B is an enlarged view of part A of the FIG. 3A;

FIG. 4A is a section view of the second embodiment of the present invention in an installation state.

FIG. 4B is an enlarged diagram of part B of the FIG. 4A.

FIG. 5 is an explosion view of a third embodiment of the present invention.

### DESCRIPTION OF THE PREFERRED EMBODIMENTS

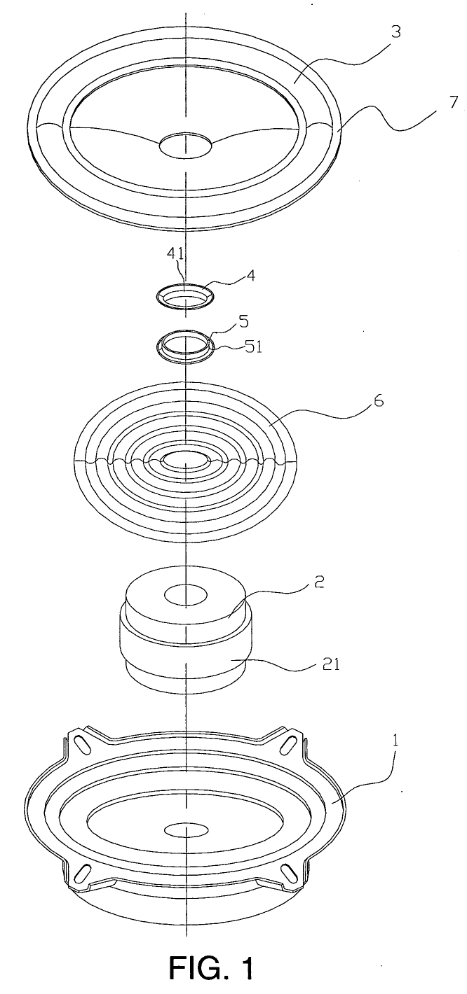

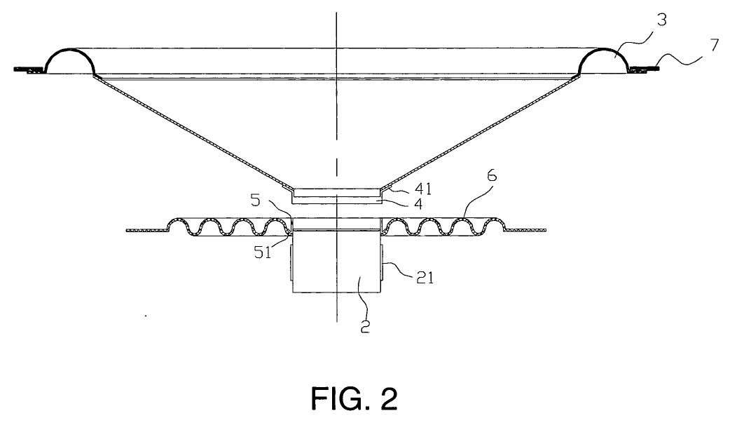

As shown in FIG. 1 and FIG. 2, a loudspeaker having a separable diaphragm comprises a cone frame 1, a voice coils 2, a diaphragm 3, a diaphragm connector 4 shaped as a cylinder generally, a elastic wave sheet connector 5 shaped as a cylinder generally, a elastic wave sheet 6, and a frame pressure ring 7.

The voice coil 2 is yoked in the cone frame 1, and a plurality turns of electrical wire 21 is wound around the external of the voice coil 2.

The elastic wave sheet 6 and the elastic wave sheet connector 5 are yoked on the outside of the top of the voice coil 2. The elastic wave sheet connector 5 is stuck in a installation aperture located on the middle of the elastic wave sheet 6. A connection member 51 is extending from the elastic wave sheet connector 5 in the direction through the installation aperture on said elastic wave sheet 6, and is connected to the elastic wave sheet 6.

The diaphragm connector 4 is connected to the outside of the cone bottom of the diaphragm 3. The diaphragm connector 4 and the diaphragm 3 can be independent assembly part. A connection member 41 is extending from the diaphragm connector 4 in the direction to the outside of the bottom of the diaphragm 3, and is connected to the outside portion of the bottom of the diaphragm 3.

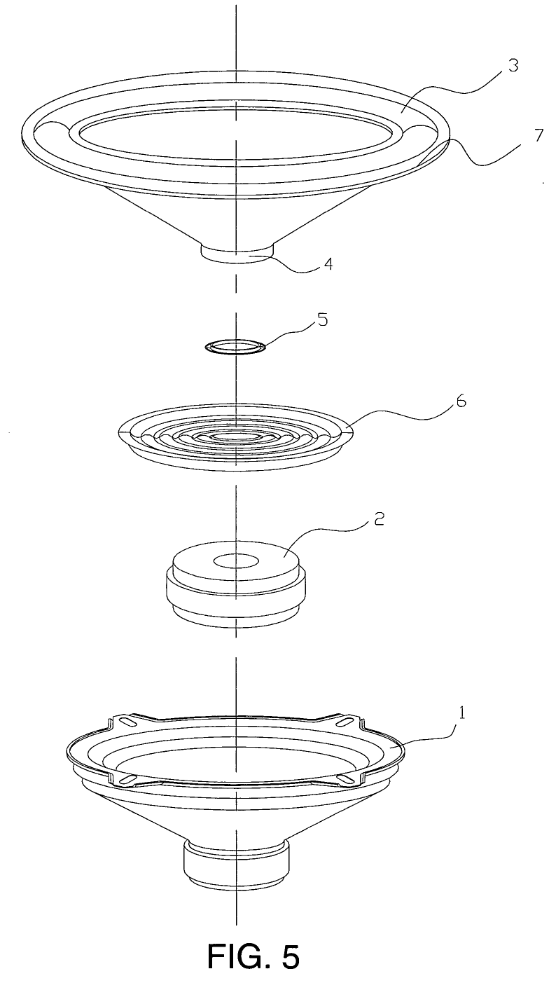

The diaphragm connector 4 also can be molded together with the diaphragm 3 as shown in FIG. 5, ejected out as a unique form.

The frame pressure ring 7 covers the outside edge of the cone top of the diaphragm 3 and is connected to the cone frame 1 to form a body.

The elastic wave sheet connector 5 and the diaphragm connector 4, or the frame pressure ring 7 and the cone frame 1 are all separable connected. The elastic wave sheet connector 5 and diaphragm connector 4 could be screwed together. The elastic wave sheet connector 5 and the diaphragm connector 4, or the frame pressure ring 7 and the cone frame 1 can also be wedged together. The elastic wave sheet connector 5 and the diaphragm connector 4, or the frame pressure ring 7 and the cone frame 1 can also be bolted together, on the corresponding spot of the elastic wave sheet connector 5 and the diaphragm connector 4, or the surround 7 and the cone frame 1 have multiple installation apertures, a plurality of screws or pins pin through the installation apertures to fasten the elastic wave sheet connector 5 and the diaphragm connector 4, or the surround 7 and the cone frame 1 together.

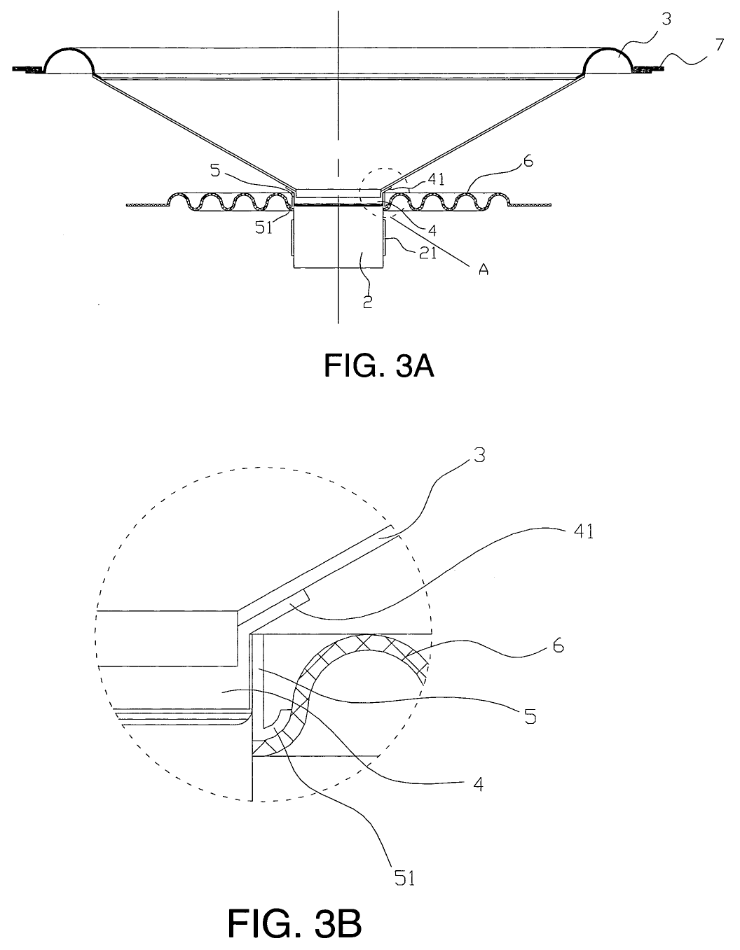

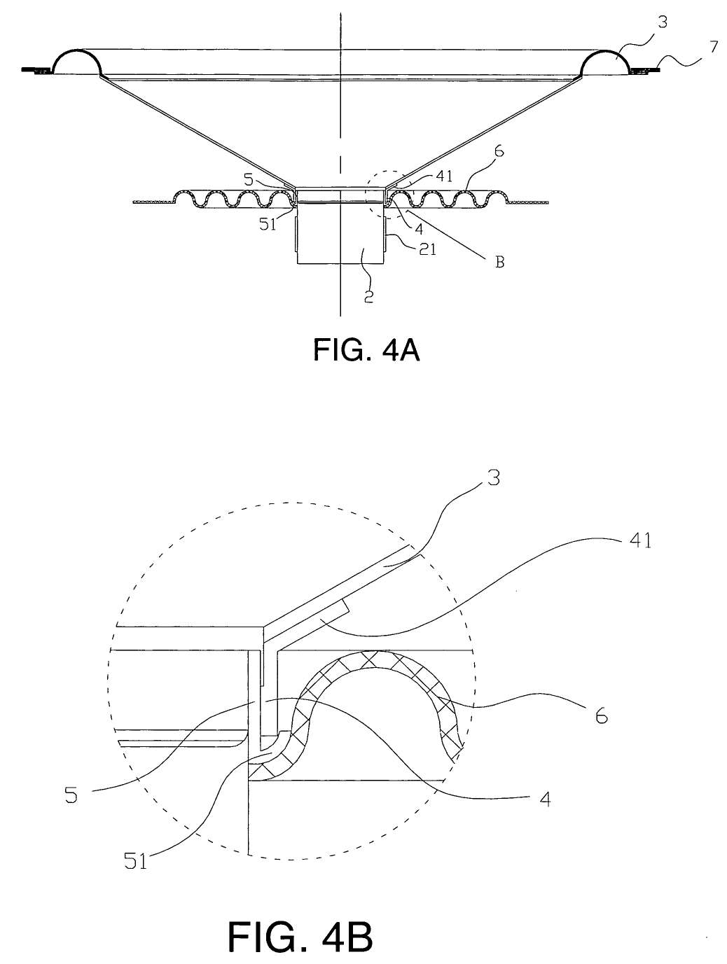

The connection position of elastic wave sheet connector 5 and the diaphragm connector 4 has two places, one is as shown in FIG. 3A to FIG. 3B that the elastic wave sheet connector 5 is yoked on the outside of the diaphragm connector 4; the other one is as shown in FIG. 4A through 4B that the diaphragm connector 4 is yoked outside the elastic wave sheet connector 5.

During the manufacturing of the loudspeakers, the normal steps are sticking (gluing) the elastic wave sheet connector 5 with elastic wave sheet 6 together, sticking (gluing) the diaphragm connector 4 and the diaphragm 3 together, and then constructing the elastic wave sheet connector 5 and the diaphragm connector 4 together, inserting the voice coils 2 into the installation apertures of the elastic wave sheet connector 4 and the diaphragm connector 4, and then gluing the elastic wave sheet connector 5 and voice coils 2 together, finally installing the frame pressure ring 7 to form a loudspeaker.

While the present invention has been described in connection with the preferred embodiment of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

I claim:

1. A loudspeaker having a separable diaphragm, comprising:
a cone frame;
a voice coil yoked in said cone frame and having a plurality turns of wire wound around the external of said voice coil;
a diaphragm shaped as a cone structure and having an installation aperture in the middle of the bottom of said diaphragm, and installed on the hatch of said cone frame and located outside of said voice coil;
an elastic wave sheet having an installation aperture in the middle of itself and yoked on the top of said voice coil;
an elastic wave sheet connector set in said installation aperture on said elastic wave sheet;
a diaphragm connector set on the outside of the bottom of said diaphragm; and
a frame pressure ring installed on the top of said diaphragm and connected to said cone frame to fasten said diaphragm into the said cone frame;
wherein said elastic wave sheet connector and said diaphragm connector being movably and separably connected, all of said frame pressure ring, said diaphragm and said cone frame being movably and separably connected.

2. The loudspeaker of claim 1, wherein said elastic wave sheet connector and said diaphragm are screwed together.

3. The loudspeaker of claim 1, wherein said elastic wave sheet connector is wedged to said diaphragm connector.

4. The loudspeaker of claim 1, wherein said elastic wave sheet connector is bolted to said diaphragm connector, said elastic wave sheet connector having a plurality of first apertures, said diaphragm connector also having a plurality of second apertures aimed at said first apertures, a plurality of bolts or pins inserting in both said first apertures and said second apertures to fasten said elastic wave sheet connector to said diaphragm.

5. The loudspeaker of claim 1, wherein said frame pressure ring is wedged to said cone frame;

6. The loudspeaker of claim 1, wherein said frame pressure ring is bolted to said cone frame, said frame pressure ring having a plurality of first apertures, said cone frame also having a plurality of second apertures aimed at said first apertures, a plurality of bolts or pins inserting in both said first apertures and said second apertures to fasten said frame pressure ring to said cone frame.

7. The loudspeaker of claim 1, wherein said diaphragm connector is molded together with said diaphragm.

8. The loudspeaker of claim 1, wherein said diaphragm connector is an independent assembly part, said diaphragm connector being stuck on the outside of the bottom of said diaphragm.

9. The loudspeaker of claim 1, wherein a connection member is extending from said diaphragm connector in the direction to the outside of the bottom of said diaphragm, and is connected to the outside portion of the bottom of said diaphragm.

10. The loudspeaker of claim 1, wherein a connection member is extending from said elastic wave sheet connector in the direction through said installation aperture on said elastic wave sheet, and is connected to said elastic wave sheet.

11. The loudspeaker of claim 1, wherein said elastic wave sheet connector is stuck to said elastic wave sheet.
